(19) United States
(12) Patent Application Publication
(10) Pub. No.: US 2005/0125715 A1
(43) Pub. Date: Jun. 9, 2005

(54) Method of saving data in a graphical user interface

(76) Inventors: Fabrizio Di Franco, Ottawa (CA); Colin Gajraj, Ottawa (CA)

Correspondence Address: TROP PRUNER & HU, PC, 8554 KATY FREEWAY, SUITE 100, HOUSTON, TX, 77024, US

(21) Appl. No.: 10/727,767

(22) Filed: Dec. 4, 2003

(51) Int. Cl. G06F 17/21

(52) U.S. Cl. 715/505; 715/506

(57) ABSTRACT

A method and software code are provided for the storage of display values from one or more fields of a form of a graphical user interface (GUI) application running on a computing device. In response to a save command by a user of the computing device in relation to an open form, for each field of the form containing display values, the display values are saved in a data storage file. Then in response to a load command by a user in relation to an open form and a designated or default data storage file, the fields of the form are populated with the display values stored in the file. This enables a user of a GUI application to customize the application with no programming knowledge.

### FIELD OF THE INVENTION

The present invention relates to saving data which is input into a form of a graphical user interface application.

### BACKGROUND OF THE INVENTION

Many different types of forms are presented to users of computing devices by graphical user interface (GUI) applications. The user fills in the form, which may be presented as a GUI window on a screen or display of the computing device. The GUI window may list the type of data which is required to be filled in and may have a designated space or box on the window for the user to input the required data, for example by typing the data using a keyboard of the computing device. Such forms may be downloaded over a communications network to which the computing device is connectable to, for example from an internet or intranet.

Often the same data has to be repeatedly filled into one or more forms, which can be time consuming for the user. This is especially the case, for example, on small hand held computing devices where the inputting of data can be awkward.

The computing devices on which such GUI applications are run may be stationary or mobile computing devices. For example, they may be stand alone computing devices or workstations networked in a computer network. Where the computing device is mobile, it may for example, be integrated into a telecommunications device, such as a mobile telephone, and may be a lap top or palm top computing device.

It is known to use templates in GUI applications to store a set of designated data, for example default data or personalized data, which can then be input in a form automatically, for example when a form of the GUI application is opened. Thus, templates are objects which store data which would otherwise have to be input manually and so are valuable time saving devices in GUI applications. A shortcoming with templates is that they must be supported by custom software code in the GUI application and must be re-programmed for each new set of designated data. Thus, from a programming point of view it is relatively expensive to program full and flexible template support in GUI applications both from an effort and a cost standpoint.

### SUMMARY OF THE INVENTION

In accordance with a first aspect of the invention there is provided a method operating on a computing device for the storage of display values from one or more fields of a form of a graphical user interface (GUI) application running on the computing device, the method comprising:
in response to a save command by a user of the computing device in relation to an open form, for each field of the form containing display values, saving the display values in a data storage file, and
in response to a load command by a user in relation to an open form and a designated or default data storage file, populating the fields of the form with the display values stored in the file.

In accordance with a second aspect of the present invention there is provided computer executable software code stored on a computer readable medium for storing display values from one or more fields of a form of a graphical user interface (GUI) application, comprising:
software code which in response to a save command by a user of a computing device on which the software code is run, in relation to an open form, for each field of the form containing display values, saves the display values in a data storage file, and
software code which in response to a load command by a user in relation to an open form and a designated or default data storage file, populates the fields of the form with the data stored in the file.

In accordance with a third aspect of the present invention, there is provided computer readable software code for operating on a computing device for storing display values from one or more fields of a form of a graphical user interface (GUI) application running on the computing device, comprising:
in response to a save command by a user of the computing device in relation to an open form, for each field of the form containing display values, software code which saves the display values in a data storage file, and
in response to a load command by a user in relation to an open form and a designated or default data storage file, software code which populates the fields of the form with the display values stored in the file.

The present invention enables a user of a GUI application to customise the application with no programming knowledge. For example, a user can fill in a form with data the user selects and then store that selected data in a data storage file and then when the user requires, that selected data can be used to repopulate a form opened by the user at any time.

In order for the display values to repopulate an open form, a relationship may be set up between the fields of the GUI application and the display values stored in relation to those fields in the data storage file. A correlation for each field of the form may be stored, for example in a user editable format, in the data storage file wherein each correlation is a correlation between a field element identifier in the GUI application for that field and the display value for that field. In particular, a correlation for each field of the form may be stored in the data storage file as name/value pairs, where for each field of the form the name is an element identifier in the GUI application and the value is the display value for that field.

The display values may be stored in the data storage file in a user editable format so as to enable a user to add, delete or amend the display values for future population of forms.

For example, in response to a save command by a user of the computing device in relation to an open form, for each field of the form containing display values, a correlation may be created comprising a field element identifier in the GUI application for that field and the display value for that field and the one or more created correlations may be stored in a data storage file, and in response to a load command by a user in relation to an open form and a designated or default data storage file, each field where a match occurs between the field element identifiers of the fields of the form and the field element identifiers of the correlations in the file may be identified and then each such identified field of the form may be populated with the display value stored in the file for the matched correlation.

The fields may include box fields and data type descriptor fields. In the case of box fields the display values are data displayed in boxes on the form. Box fields can, for example, be used to store data, such as default data or personalized data, which a user may wish to repeatedly input into a form. In the case of data type descriptor fields the display values are data type descriptors. Data type descriptor fields can be amended, for example, to change the language in which a form is presented.

In response to a request from a user, the form may be displayed on a display of the computing device for a user to input data in fields of the form and an activator icon may also be displayed on the form, in which case in response to a user actuating the activator icon, an array of options including a save command actuator which a user actuates to make a save command and a load command actuator which a user actuates to make a load command may be displayed.

The saving of the display values in a data storage file may be achieved by displaying a file save window for a user to create or select a file in which to save the display values. Alternatively, it may be achieved without user intervention, by automatically generating a file in a default location of the computing device, naming the file after the title of the form and storing the display values in the file.

The populating of the fields of the form with the display values stored in the file may be achieved by displaying a file picker window for a user to select a data storage file from which to load the display values. Alternatively, it may be achieved without user intervention automatically by selecting a file in a default location with the same name as the title of the form from which to load the display values.

A user may designate a data storage file as a default file for a form and in response to this the fields of the form may be automatically populated with the display values stored in the file when a new version of the form is opened.

In response to a request by a user the contents of a data storage file may be displayed on a display of the computing device in a user editable format. Also, a user may make a request in response to which a screen listing GUI application element names in relation to fields of the form may be displayed. This enables a user to easily access the GUI application element names. Knowing the GUI application element names makes it easier for a user to edit a data storage file.

An activation interface may be generated on the computing device, which interface is actuable by the user of the computing device to facilitate storage of display values to a data storage file or loading of display values from a data storage file. Many such activation interfaces are known in the art and could be suitable for use with the present invention. In particular an activation interface may be displayed on the open form so that it is actuable by the user to facilitate storage of display values to a data storage file or loading of display values from a data storage file.

The present invention may be implemented in software, for example, stored as computer program code on a computing device or in or on a computer readable medium.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

In order that the present invention is more fully understood and to show how the same may be carried into effect, reference shall now be made, by way of example only, to the Figures as shown in the accompanying drawing sheets, wherein:

FIG. 1 shows an example form window of a database records system which incorporates the DropZone™ system according to the present invention;

FIG. 2 shows an example of a form-picker window for selecting DropZone™ files in the system described in relation to FIG. 1;

FIG. 3 shows an example of a file window for saving DropZone™ files in the system described in relation to FIG. 1;

FIG. 4 shows an example of a file window on which is diplayed the contents of a DropZone™ file in editable form;

FIG. 5 shows an example of a file window on which is diplayed the contents of a DropZone™ file;

FIG. 6 shows an example of a file window on which is displayed a radar screen which displays the GUI application field element names in relation to the fields of the form window of FIG. 1;

FIG. 7 shows an example of a file window on which is displayed an empty default assignments file according to the present invention;

FIG. 8 shows an example of a file window on which is displayed a default assignments file providing instructions for default in-filling of the form window of FIG. 1 according to the present invention;

FIG. 9 shows a table of the representations of GUI application field elements;

FIG. 10 shows a table of DropZone™ file save mechanisms;

FIG. 11 shows a class diagram of an implementation of the DropZone™ system according to the present invention;

FIG. 12 shows a sequence diagram of the DropZone™ component interaction according to the implementation of the present invention shown in FIG. 11;

FIG. 13 shows a flow diagram of the steps carried out by a user and by the DropZone system in a loading mechanism according to the present invention;

FIG. 14 shows a flow diagram of the steps carried out by a user and by the DropZone system in a one click load mechanism according to the present invention;

FIG. 15 shows a flow diagram of the steps carried out by a user and by the DropZone system in a save mechanism according to the present invention;

FIG. 16 shows a flow diagram of the steps carried out by a user and by the DropZone system in a one click save mechanism according to the present invention;

FIG. 17 shows a flow diagram of the steps carried out by a user and by the DropZone system in an editing mechanism according to the present invention;

FIG. 18 shows a flow diagram of the steps carried out by a user and by the DropZone system to display an information screen according to the present invention;

FIG. 19 shows a flow diagram of the steps carried out by a user and by the DropZone system in a reset mechanism according to the present invention;

FIG. 20 shows a flow diagram of the steps carried out by a user and by the DropZone system in an assignment of default data mechanism according to the present invention; and

FIG. 21 shows a flow diagram of the steps carried out by a user and by the DropZone system in a loading of default data mechanism according to the present invention after it has been saved according to the mechanism shown in FIG. 20.

### DETAILED DESCRIPTION OF PREFERRED EMBODIMENTS

There will now be described by way of example the best mode contemplated by the inventor for carrying out the invention. In the following description, numerous specific details are set out in order to provide a complete understanding of the present invention. It will be apparent, however, to those skilled in the art that the present invention may be put into practice with variations of the specific.

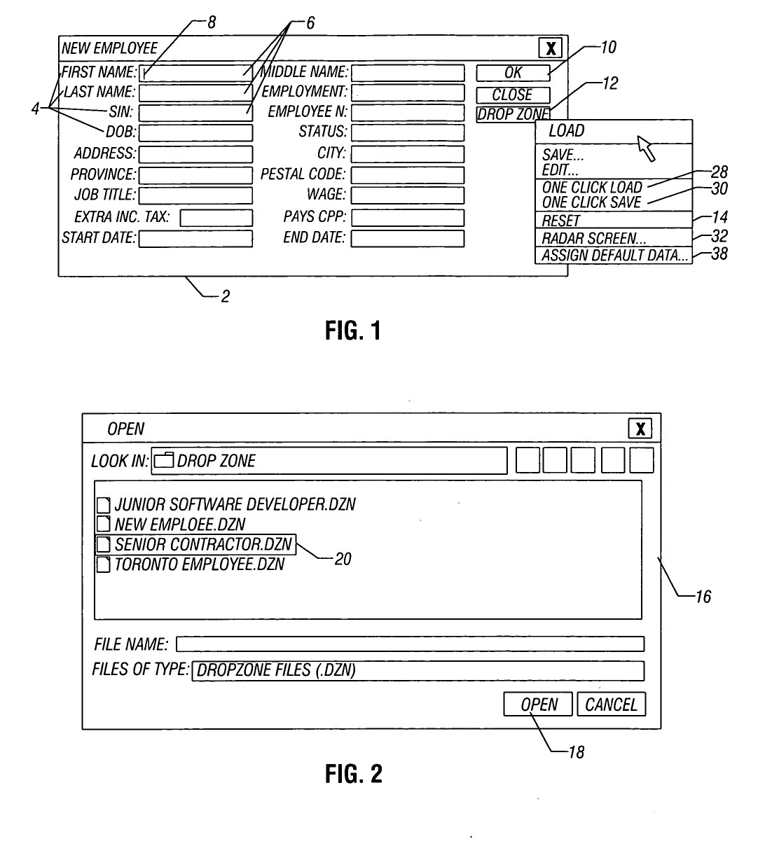

FIG. 1 shows a single form window (2) of a form displayed on a screen of a computing device when a GUI application is run on the computing device. The opened form window (2) displays a first set of fields which display a set of data type descriptors (4), such as First name, Last name and SIN. Adjacent each descriptor is one of a second set of fields which are displayed as blank boxes (6) within the window.

The boxes (6) need not be blank but may contain data. To fill in the form a user of the computing device moves a cursor (8) to the box which is to be filled in and inputs relevant data corresponding to the adjacent descriptor. The user may wish to enter in data to some or all of the boxes before clicking on the OK button (10) located in the form window (2) to initiate some action by the GUI application.

In the example of FIG. 1, when the form window (2) is opened for the first time the boxes (6) are all blank. However, this need not be the case and certain boxes may be automatically filled in on the opening of the window, for example, in accordance with a template programmed in the GUI application. For example, certain boxes may automatically be filled by default data or personalized data. In the example in FIG. 1 the form is for storing the details of new employees on a records system used in a personnel department of an organisation.

According to the present invention a DropZone™ system enables a user to automatically add, delete or amend some or all of the fields on a form window (2), as is described below. The amended fields may be boxes (6) or data type descriptors (4) or a combination of both types of field. The fields are amended to display the data stored in a DropZone™ file. This file will have been previously saved by the user, as is described below.

In order to store and to make these changes to the fields, there must be a relationship between the data to be displayed in the fields (6) of the form as stored in a DropZone™ file and the corresponding elements as recognised by the GUI application.

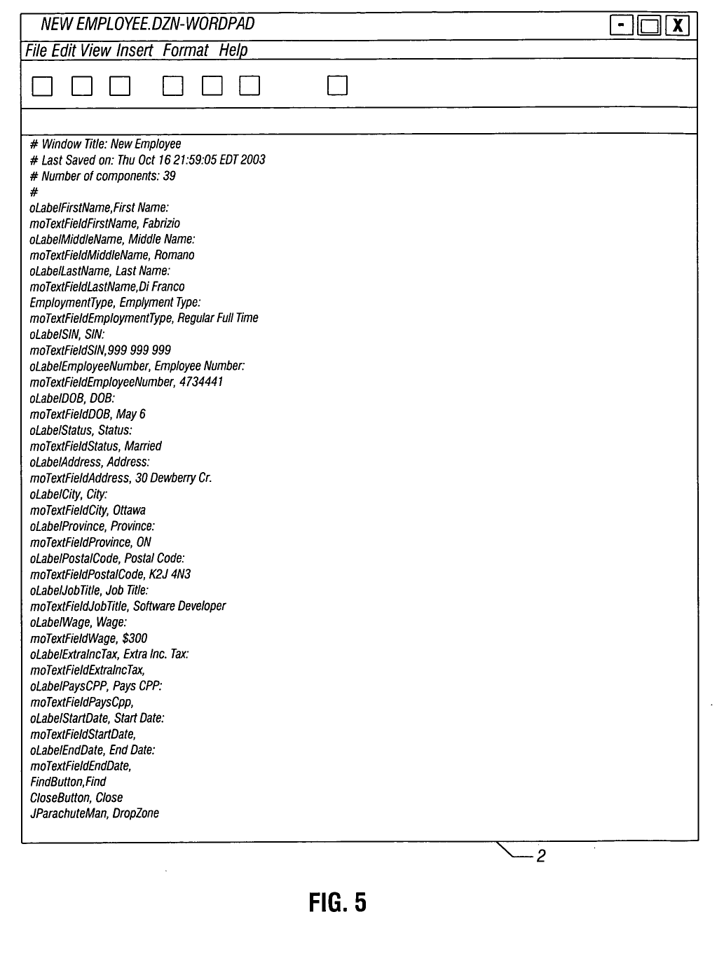

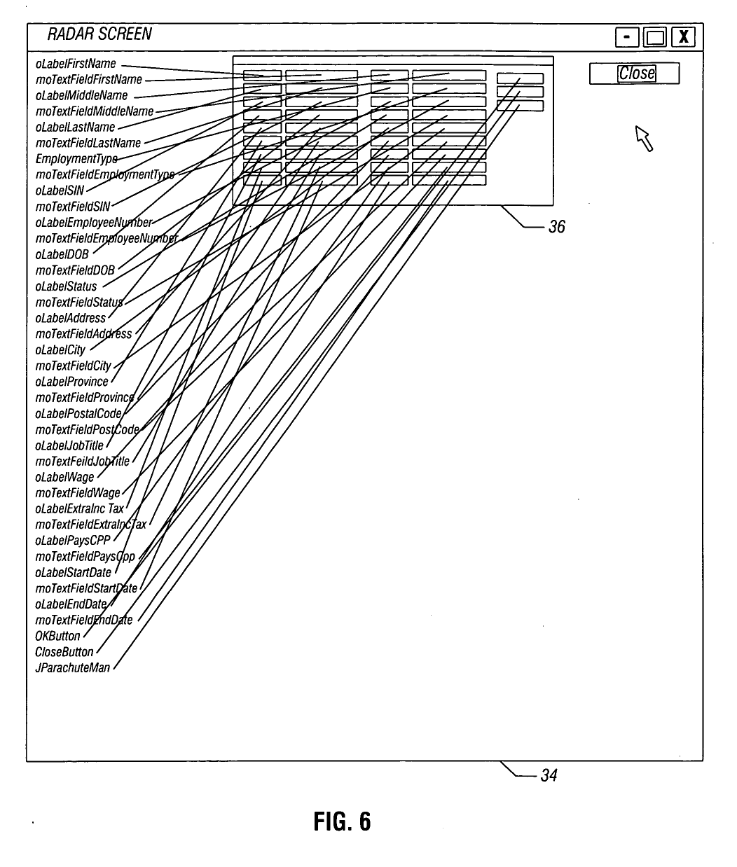

An example of the format which could be used for displaying the contents of a DropZone file is shown in Microsoft® WordPad in FIG. 5. The first four lines of the WordPad window (26) are reserved by default for comments describing the contents of the file, such as the title of one or more form windows (2) to which the file relates, the date that the data in the DropZone™ file was last saved and the number of components making up the file. The number of components is the number of spaces on the form window (2), including spaces for data type descriptor fields (4), box fields (6) and buttons (10, 12) as shown in the graphical representation (36) on the radar screen (34) of FIG. 6. The next part of the file is a series of name/value pairs that are delimited by a comma.

In the example shown in FIGS. 4 to 6, the lines of a file beginning with ‘o’ are name/value pairs which relate to the data descriptor fields (4).

So the first line of the DropZone™ file of FIG. 5 beginning with ‘o’ is as follows:
oLabelFirstName,First Name:

In this example, the name (to the left of the comma) is the GUI element name associated by the GUI application with a data type descriptor (4) used on the form window (2), ie. LabelFirstName. The GUI element name is that name which was designated by the programmer of the GUI application. The value (to the right of the comma) is that value to be displayed on the form window (2) as the data type descriptor (4), ie. First Name:.

A data type descriptor field (4) can be removed from the form window (2) by deleting one of the lines of the file beginning with a ‘o’. Additional data type descriptors can be added to the form window (2) by adding an additional line to the file beginning with an ‘o’ and using an element name recognised by the GUI application. Also, the data type descriptor (4), as displayed on the form window (2) can be amended by amending the value to the right of the comma in lines of the file beginning with an ‘o’. For example, to change the form window (2) from English language into French language, the values to the right of the comma in the lines of the file of FIG. 5 beginning with an ‘o’ are simply amended from being written in English language to being written in French language.

In the example shown in FIGS. 4 to 6, the lines of the file beginning with ‘mo’ are name/value pairs which relate to the boxes (6). All name value pairs should be on a different line.

So the first line of the DropZone™ file of FIG. 5 beginning with ‘mo’ is as follows:
moTextFieldFirstName, Fabrizio

In this example, the name (to the left of the comma) is the GUI field name associated by the GUI application with a box (6), ie. TextFieldFirstName and the value (to the right of the comma) is the text to be displayed in that box (6) of the form window, ie. Fabrizio. Where there is no value to the right of the comma, then the box is displayed as a blank box.

A box (6) of the form window (2) can be removed from the form window (2) by deleting one of the lines of the file beginning with ‘mo’. The data contained in a box (6) of the form window (2) can be removed by deleting the value to the right of the comma in the relevant line of the file beginning with ‘mo’. Additional boxes (6) be added to the form window (2) by adding an additional line to the file beginning with ‘mo’ and using an element name recognised by the GUI application. Additional data can be added to a box (6) of the form window by adding the data as a value to the right of the comma of a line of the file beginning with an ‘mo’. Also, the data as displayed in the boxes (6) of the form window (2) can be amended by amending the value to the right of the comma in the relevant lines of the file beginning with ‘mo’.

The identifiers ‘o’ and ‘mo’ are arbitrary selections and other identifiers could be used in their place.

In the flow diagrams of FIGS. 13 to 21, the actions performed by the user of the computing device are listed to the left side of a dotted line and the steps performed by the DropZone system are listed to the right side of the dotted line.

A first embodiment of the present invention will be described below in which the DropZone™ system according to the present invention is used for manipulating data input by a user into the boxes (6). For example, where the user does not currently have all the data required to fill in the form and would like to save the data input so far so as to avoid having to input it again, the DropZone™ system can be used to save the already input data and re-input it automatically into the relevant form window when the user obtains the additional required information. Alternatively, it could be that the filling in of the form is a repetitive task and that certain data will have to be re-input in future repetitions of the form filling task. In this case, the DropZone™ system can be used to save the data that has to be re-input each time the task is repeated and to re-input it automatically into the relevant form window, as required.

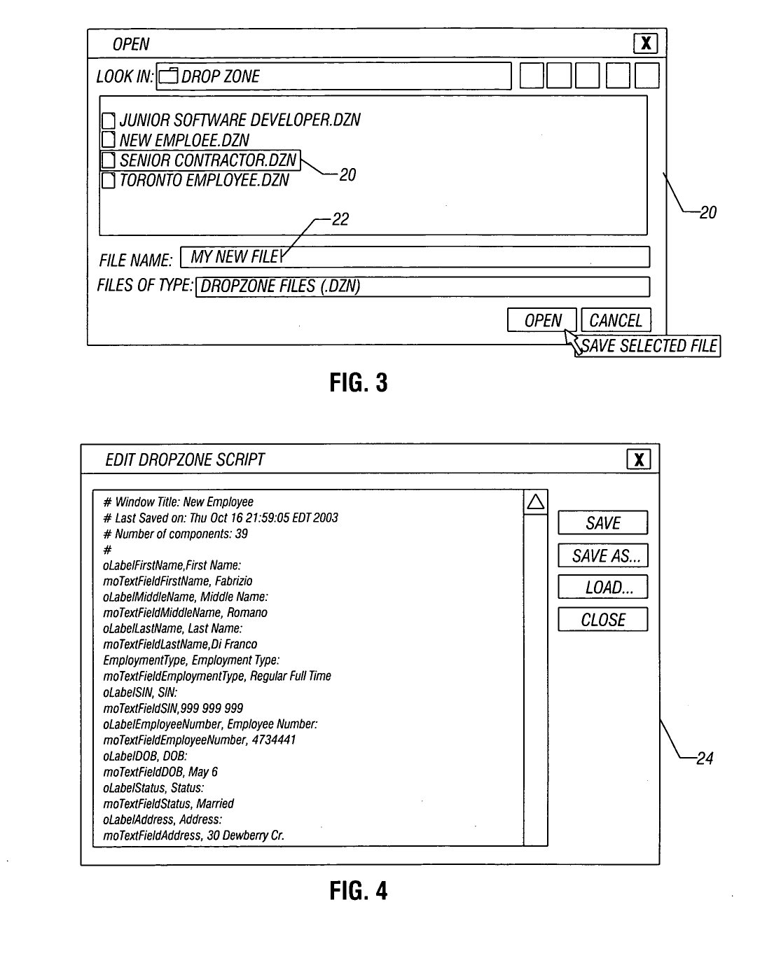

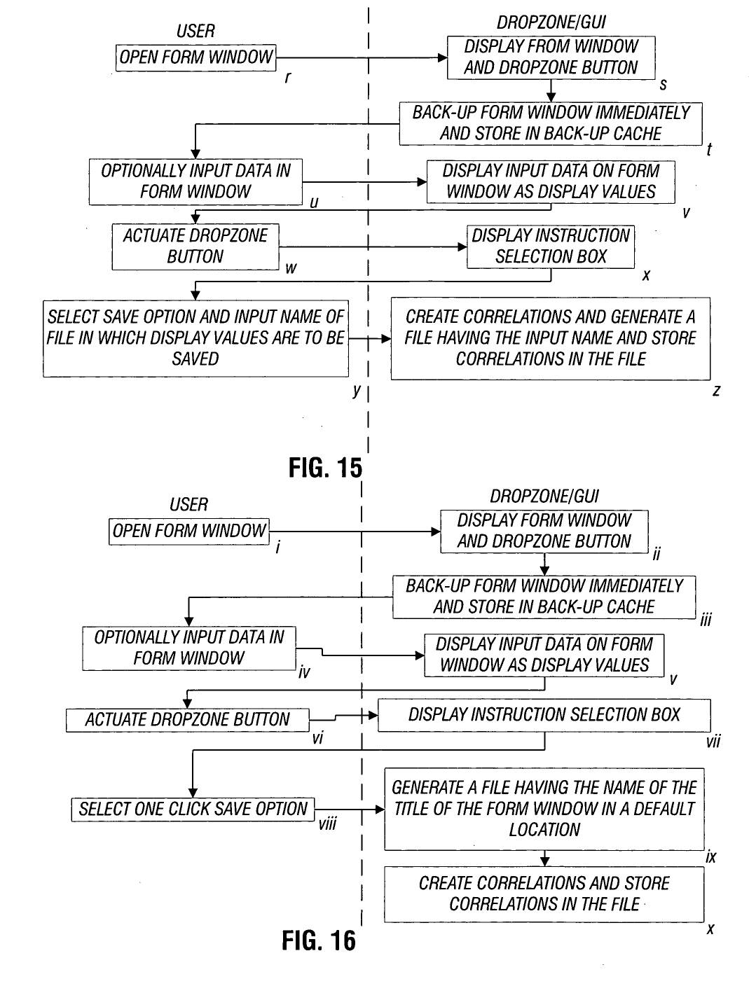

When a form window (2) is opened for the first time [Box r and s, FIG. 15], it may appear with some or all of the boxes (6) blank, as shown in the example in FIG. 1. The form window is displayed on the screen of the computing device and also displayed within the form window is a DropZone button (10) [Box s, FIG. 15]. The user may wish to enter in values for some or all of the boxes (6) [Box u, FIG. 15], which values are displayed on the screen [Box v, FIG. 15], before clicking on the OK button (10) to initiate some action. However, before clicking on the OK button the user may wish to save the data which has been filled in on the form thus far. The open form window (2) displays a DropZone button (10). According to this first embodiment, when the DropZone™ button is clicked by a user [Box w, FIG. 15], an instruction selection box (14) is displayed on the screen of the computing device [Box x, FIG. 15]. To save the data already input in the boxes (6) of the form window (2) the user clicks on the DropZone™ button (10) of the form window (2) to display the instruction selection box (14) and then selects the ‘Save’ option from the box (14) [Box y, FIG. 15]. In response to this a standard file save window (20), for example as shown in FIG. 3, is displayed on the screen so that the user can select a destination folder and DropZone™ file name for the data to be saved. The user can input a new file name in the ‘file name’ box (22) or can select to re-write the data to an already existing file, eg. file (20) named ‘senior contractor.dzn’. The display values from the form window (2) including data input by the user are stored in the newly named or selected file as correlations, for example as name/value pairs as described above [Box z, FIG. 15].

Where the user wishes to load data from a DropZone™ file into the boxes (6) of an open form window (2), the DropZone™ button (10) is clicked by a user [Box d, FIG. 13] and an instruction selection box (14) is displayed on the screen of the computing device [Box e, FIG. 13]. Then the user selects the ‘Load’ option of the instruction selection box (14) [Box f, FIG. 13] and a standard file-picker window (16), shown in FIG. 2 is displayed on the screen of the computing device [Box g, FIG. 13]. The user then selects the appropriate one of the listed and previously saved DropZone™ files, in this example ‘senior contractor.dzn’, and then clicks on the open button (18) [Box h, FIG. 13]. This action fills in the boxes (6) of the form window (2) with data stored in the file ‘senior contractor.dzn’ [Box i, FIG. 13]. Alternatively, where the form window (2) and the file-picker window (16) are presented side by side on the screen of the computing device, the file system's drag and drop mechanism could be used to drag the relevant file icon (20) over onto the form window (2) and to drop the icon on the DropZone™ button (12) of the form window (2). This icon (20) represents a file that was previously saved, as described below. Similarly, this action fills in the boxes (6) of the form window (2) with data stored in the file ‘senior contractor.dzn’.

For example, a user might wish to fill in the boxes (6) of the form window (2) with descriptors ‘Address’, ‘City’, ‘Province’ and ‘Postal Code’ and then use the DropZone™ button (10) and the ‘Save’ option from the instruction selection box (14) to save personalized address information in a new file with a file name ‘address.dzn’. Then when the user has to next fill out a form window requiring address information and using the same GUI element names, the DropZone™ button (10) and the ‘Load’ option from the instruction selection box (14) could be used to fill in the boxes (6) of the form window (2) with descriptors ‘Address’, ‘City’, ‘Province’ and ‘Postal Code’ by selecting the file having the file name ‘address.dzn’.

As described above, when a user elects to save data using the DropZone™ button (10) and the ‘save’ option, the data in all of the fields (6) filled in at that time on the form window (2) are saved by default. This may be more or less information than the user wishes to save and the user may wish to add or remove some of the fields or elements for which data is saved.

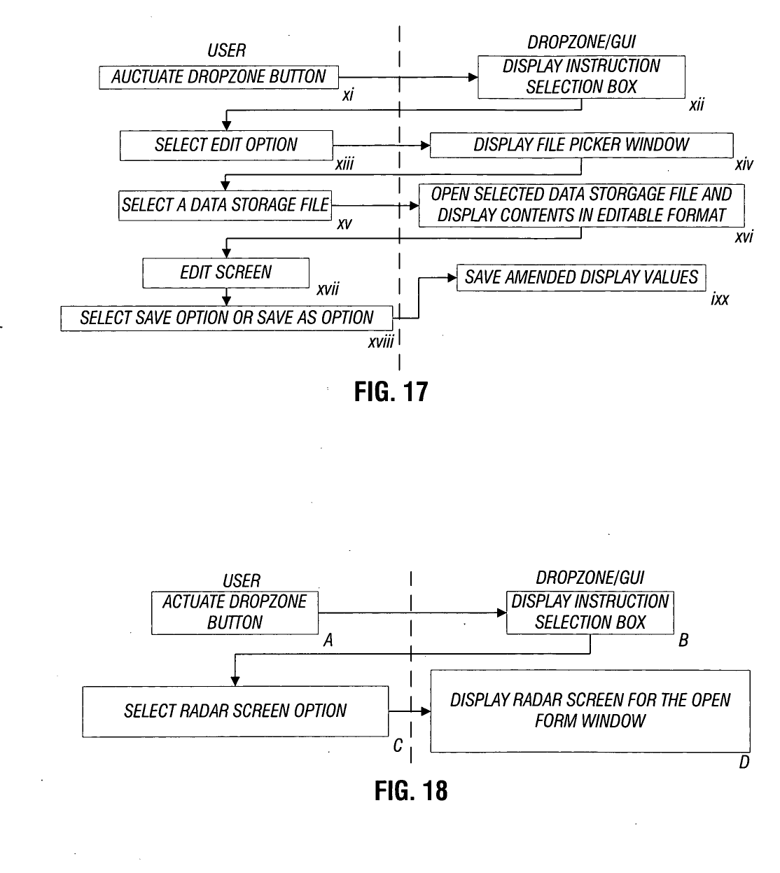

According to a second embodiment of the present invention, the DropZone™ system can be used to change the data type descriptor fields of a form window (2). For example, the present invention enables a form window to be translated into different languages without having to re-program the GUI application. In the present example, a user would simply open the form window (2) and before inputting any data into the form window would press the DropZone™ button (10) [Box xi, FIG. 17]. Then the edit option would be selected from the instruction selection box (14) [Box xii and xiii, FIG. 17] and a file picker window would be displayed [Box xiv, FIG. 17] from which a data storage file would be selected [Box xv, FIG. 17]. The selected data storage file is opened and its contents are displayed on the screen as an edit DropZone Script file [Box xvi, FIG. 17]. The edit DropZone Script file could then be edited by amending the values after the comma in the name/value pairs beginning with ‘mo’ so that the value is in the different language [Box xvii, FIG. 17]. The edit DropZone Script file is then saved using the ‘Save As’ button, for example the file could be called ‘new language.dzn’ [Box xviii and ixx, FIG. 17]. Then when the form window (2) is required in the different language, the DropZone™ file entitled ‘new language.dzn’ is simply loaded onto the form window (2).

To edit a DropZone™ file, the DropZone™ button (10) on a relevant form window (2) is clicked [Box xi, FIG. 17] and the ‘Edit’ option is selected from the instruction selection box (14) [Box xii and xiii, FIG. 17]. In response, a standard file-picker window (16), shown in FIG. 2 is displayed on the screen of the computing device [Box xiv, FIG. 17]. The user then selects the appropriate one of the listed DropZone™ files to edit, in this example ‘senior contractor.dzn’, and then clicks on the open button (18) [Box xv, FIG. 17]. In response an edit script window (24) as shown in FIG. 4 is displayed on the screen of the computing device [Box xvi, FIG. 17]. In the edit script window (24) the user is presented with all of the name/value pairs stored in the opened DropZone™ file in an editable text area. There may be some fields which are no longer of interest to the user and so the lines relating to those fields can simply be deleted. The user may wish to add additional fields to the edit script window (24) by adding additional name/value pairs. Also, existing name/value pairs can be amended, for example to change the data type descriptors (4) or the data which will populate the boxes (6) of the form window [Box xvii, FIG. 17]. Once the user has made the desired changes to the edit script window (24), the ‘Save’ or ‘Save As’ options can be selected by the user. The ‘Save’ option will use the title of the opened DropZone™ file as the title of the amended file. The ‘Save As’ option will allow the user to create a new or select an existing destination folder and file name for the amended file [Box xviii and ixx, FIG. 17].

The user may wish to populate more than one different form window from the same DropZone™ file. Consider the example in which in one GUI application there is a first form where the user is asked to fill in name, address and date of birth and in another GUI application there is a second form where the user is asked to fill in name, address and age. Then the user can create a single DropZone™ file that combines name, address, date of birth and age and use this file to populate both of the forms. This can be achieved provided the different form windows uses consistent GUI application element names.

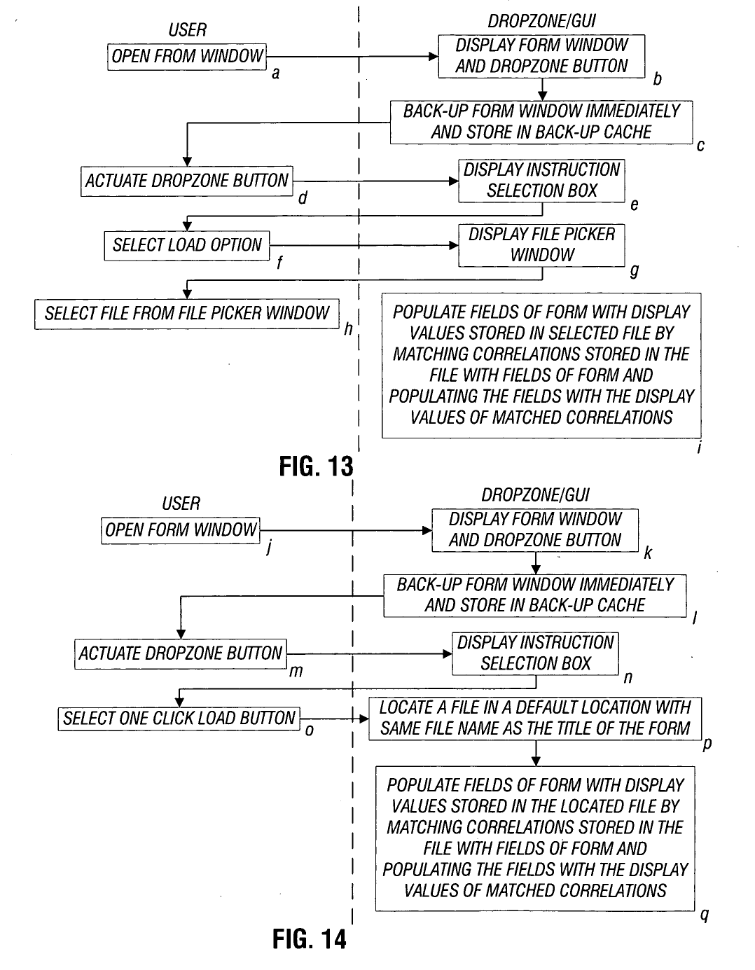

When a user is populating a form window (2) using the DropZone™ button (10) in accordance with the present invention, there is an option of loading the data by selecting ‘One Click Load’ (28) from the instruction selection box (14) [Box o, FIG. 14]. When this option is selected the DropZone™ system automatically searches a default location for a file that has the same name as the title of the form window (2) [Box p, FIG. 14]. The default location will generally be one or more folders which have been designated by the user for storing DropZone™ files. If such a file is found in the search then it is automatically loaded, ie. the form window (2) is populated with the data stored in that DropZone™ file [Box q, FIG. 14].

Similarly, when a user is saving data input in a form window (2) using the DropZone™ button in accordance with the present invention, there is an option of saving the data by selecting ‘One Click Save’ (30) from the instruction selection box (14) [Box viii, FIG. 16]. When this option is selected the data will automatically be saved in a DropZone™ file having the same name as the title of the form window (2) in a default location [Box ix and x, FIG. 16].

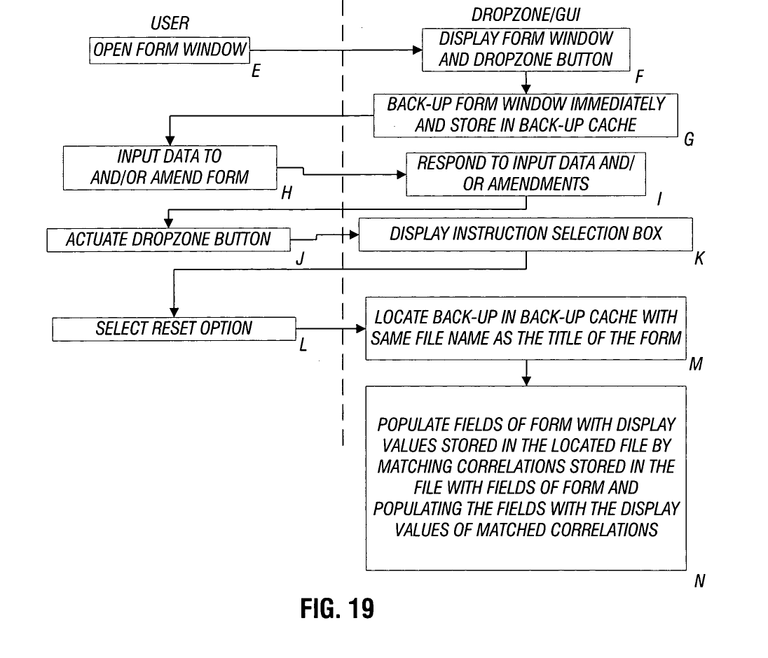

When a user clicks on the DropZone™ button (10) of the form window (2) [Box J, FIG. 19], the instruction selection box (14) is displayed, as described above [Box K, FIG. 19]. One option in the instruction selection box (14) is reset. If the user selects this option [Box L, FIG. 19] then the form window (2) reverts back to the data displayed in the fields (6) when the form window (2) was first opened [Box M and N, FIG. 19]. This option can be used to remove all DropZone™ data filling and manual data filling that has been performed since the form window (2) was opened.

The very first operation that the DropZone™ system will perform when a form window (2) [Box E, FIG. 19] is opened is to store a back up file of the display values in the form on opening of the form window in a back up cache [Box F, FIG. 19]. Again the name/value pair correlation described above will be used to store the display values. The stored back up file for an open form window (2) can be used to restore the form window (2) back to its original state when the reset option is selected. When the reset option is selected from the instruction selection box (14) [Box L, FIG. 19] the DropZone™ system iterates through the back up cache [Box M, FIG. 19] and restores all the display values on the form window (2) to those that existed immediately when the form window was opened [Box N, FIG. 19] and before the DropZone™ system performed any customized data filling.

A further option in the instruction selection box (14) of a form window (2) is the ‘Radar Screen’ option (32), which is a user-friendly way to find out the element names of the fields used on the form window (2) in the GUI application. Since the field names are generally given by the programmer of the GUI application, the user of the computing device has no easy way of knowing what the names of each field are. When the ‘Radar Screen’ option (32) is selected by a user [Box C, FIG. 18], the radar screen window (34) as shown in FIG. 6 is displayed on the screen of the computing device [Box D, FIG. 18]. The radar screen window (34) shows a miniature graphical representation (36) of the format of the form window (2). The names of the fields and buttons as used in the GUI application to identify the fields and buttons are also listed on the radar screen window (34). A key or arrows (as shown in FIG. 6) are used to link the listed names with the relevant fields or buttons of the graphical representation (36).

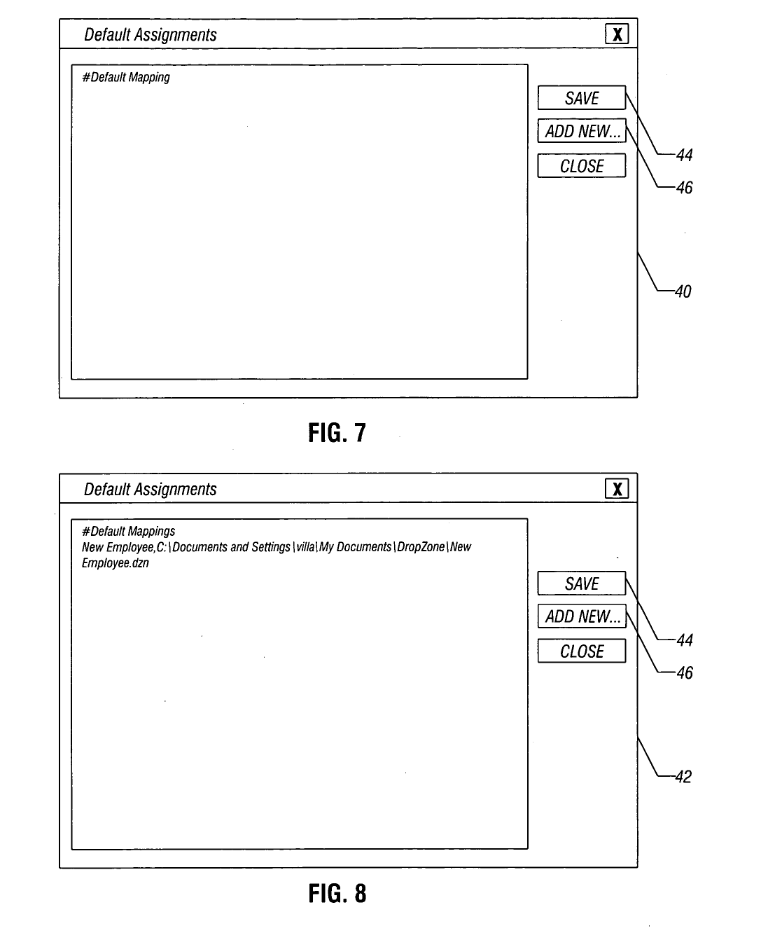

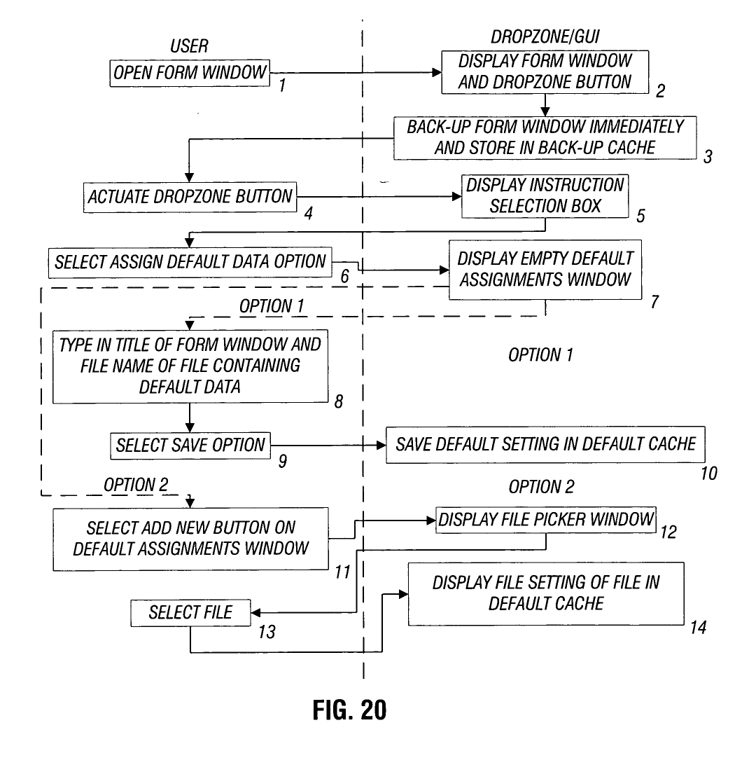

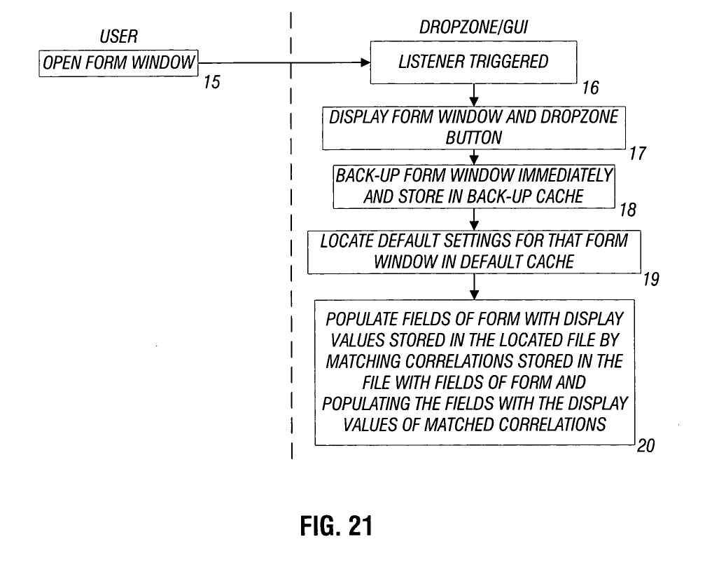

As is discussed above for some GUI applications when forms are opened, some fields are automatically populated with data, which is generally referred to as default data. In the past, the possible sets of default data have generally been selected by the programmer who writes the GUI application, for example using templates. A further option in the instruction selection box (14) of a form window (2) is the ‘Assign default data’ option (38) and gives the user the ability to select default data. When the ‘Assign default data’ option is selected [Box 6, FIG. 20], an empty default assignments window (40), as shown in FIG. 7 is displayed on the screen of the computing device [Box 7, FIG. 20]. Then according to option 1 of FIG. 20, the user can then type in the title of the form window (2) and the file name of the DropZone™ file containing the default data [Box 8, FIG. 20]. In the present example, the form window title is ‘New Employee’ and the file name containing the default data is ‘C:\Documents and Settings\villa\My Documents\DropZone\New Employee.dzn’. When this is typed in to the empty default assignments window (40) the result is the default assignments window (42) of FIG. 8. The user would then click on the ‘Save’ button (44) [Box 9, FIG. 20] and the default settings as designated in the default assignments window (40) are saved [Box 10, FIG. 20]. Then, the next time the form window (2) entitled ‘New Employee’ is opened [Box 15, FIG. 21], the fields (6) are automatically populated with the data stored in the file ‘New Employee.dzn’ [Box 16 to 20, FIG. 21]. This data overwrites any default data which populates the fields (6) in accordance with the GUI application.

Instead of typing in the form title and file name into the empty default assignments window, an alternative option 2 (shown in FIG. 20) is to click on the ‘Add New . . . ’ button on the default assignments window (40) [Box 11, FIG. 20]. This results in the file-picker window (16) being displayed on the screen of the computing device [Box 12, FIG. 20]. The user selects the file, in the present example the file named ‘New Employee.dzn’ [Box 13, FIG. 20], and then the title of the form (2) and the name of the selected file are automatically populated in to the blank screen of the default assignments window (40) to generate the default assignments window (42). The user then clicks on the ‘Save’ button (44) and the default settings as designated in the default assignments window (40) are saved [Box 14, FIG. 20]. Then, the next time the form window (2) entitled ‘New Employee’ is opened [Box 15, FIG. 21], the fields (6) are automatically populated with the data stored in the file ‘New Employee.dzn’ [Box 16 to 20, FIG. 21].

For example, where the data type descriptors have been translated into a different language, then for a person wishing to use the form in the different language, it would be efficient for that person to designate the DropZone™ file storing the data type descriptor translations as a default file for that form. Then when the form is opened it immediately displays the data type descriptors to the user in the correct language.

According to the present invention, the user has the ability to save display values from any form at any point in time. The user is free to load this data subsequently into a form window (2) either via drag and drop, one click loading, default loading or by using the file selection load mechanism, as is described above. Activation of the file selection load mechanism (in the example above by selecting the ‘load’ option on the instruction selection box (14)) brings up onto the screen of the computing device a standard ‘load’ dialog (if it exists) for the platform on which the GUI application is run. The user then selects the appropriate file. The standard files to be accepted will be, for example, text files of type ‘txt’ or ‘dz’. Once the user selects the file it is parsed by the system and loaded into the form window (2).

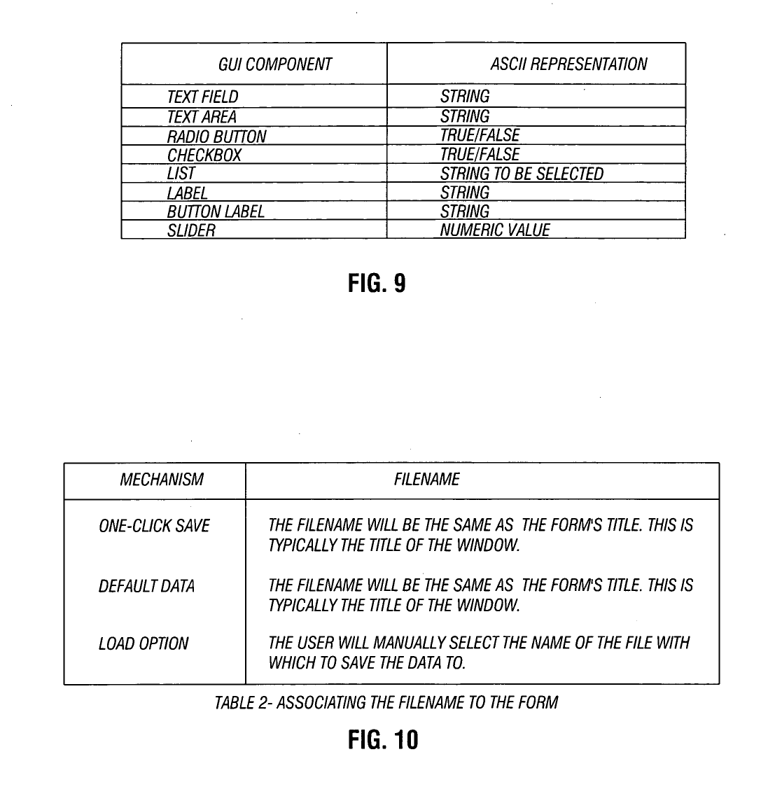

The DropZone data storage file will generally be a plain ASCII text file whereby any lines beginning with a hash sign ‘#’ will be ignored. The lines beginning with a hash will be used by the system and/or by the user for documenting the contents of the file. These lines are also known as comments. There may be a mechanism within the DropZone™ system to take a filename, open its file representation and parse the name/value pairs. The parse then searches the current form window (2) for a component matching the name of the name/value pair read from the file. It would then use the rules for populating the component based on table 1 of FIG. 9.

The Radar Screen window (34), the Default assignments window (40, 42) and the DropZone™ file editor window (24) are examples of helper dialogs which can be either modal or modeless.

As described above, there are mechanisms in the DropZone™ system for enabling a user to associate a data storage file with a form window (2). The file may be associated to the form according to table 2, shown in FIG. 10. The DropZone™ system shall add comments to the file outlining the name of the window that this file was originally applied to, the count of the number of components saved, and the date that the save occurred. After the comment block then all the fields of the saved form window (2) will be saved as name/value pairs, one per line. Optionally, data type descriptor fields may not be saved so that only editable box fields are saved.

The loading of default display values into a form [Box 19 and 20, FIG. 21] may be implemented by storing the default display values for a form in a file carrying the name of the form and using this file to load the display values into an internal cache. Optionally, the programmer may want to use a designated environment variable to store the filename and path of this file so as to de-couple default data from a hard-coded filename. Then whenever a form window is opened, the DropZone™ system will perform a primary loading mechanism by automatically checking this cache to determine if there is an entry in the cache with the given title of the window [Box 19, FIG. 21]. If there is, then the display values stored in that file are populated in the form [Box 20, FIG. 21].

In the examples given above, all the fields (6) are text fields. However, this need not be the case. For example, some of the fields could be yes/no check boxes. The table of FIG. 9 illustrates how the values are to be stored for various GUI elements. For example, Buttons have their button text saved in string format.

The DropZone™ system as described above enables a user of a GUI application to customize the application with no programming knowledge.

In its simplest forms the DropZone™ functionality, as it is described above can be implemented as a new custom component of a GUI application. Other examples of GUI components are buttons, checkboxes, editable text, etc. The DropZone™ functionality can be implemented as a custom component with all of its functionality self-contained. That is, once a user has added this component to their GUI application window then all of the accompanying functionality follows automatically.

In order for the DropZone™ component (ie that custom component implementing the DropZone™ functionality) to work, the DropZone™ component requires information about the GUI application into which it is installed. In particular it requires information about the window that it will be installed in. This window may be any type of container, for example a dialog box, a window, a frame, etc. The DropZone™ component needs to know about its container because, for example it needs to know when the container is activated, for example when the GUI application window on which it is installed is opened. The DropZone™ component needs to know when a window, for example displaying an empty form is opened, so as to populate relevant fields of the form with any default information that a user has previously stored in relation to that form. In order to achieve this, there would be a listener in the DropZone™ component which is triggered when a relevant window is opened [Box 16, FIG. 21]. For example, in the programming language Java, the DropZone™ component would register a window listener on relevant containers.

In order for the repopulation of forms by the drag and drop option discussed above to be implemented, the DropZone™ component could register itself as a droppable target. This should be possible on computing devices which support drag and drop functionality.

In the examples in the Figures, the DropZone™ component is drawn on the open window as a graphical image of a DropZone™ button (12) with ‘DropZone>’ written on it. Alternatively, a picture icon could be used instead of the DropZone™ button (12). The DropZone™ button forms an activation interface via which a user can activate the DropZone™ functionality. In particular, the DropZone™ button is an activation icon via which a user can activate the DropZone™ functionality.

The DropZone™ component interacts with the platform on which it is installed by registering itself for mouse-related events and window-related events. The mouse events are used for bringing up context-sensitive menus.

The window event, e.g., the opening of a form window, acts as a trigger for the entire functionality of the DropZone™ component. Whenever a window opens [Box 15, FIG. 21] then the primary loading mechanism [Box 19 and 20, FIG. 21] will be invoked and that mechanism will determine whether that window will be data filled based on whether there is any relevant data in the default cache for a window of that name.

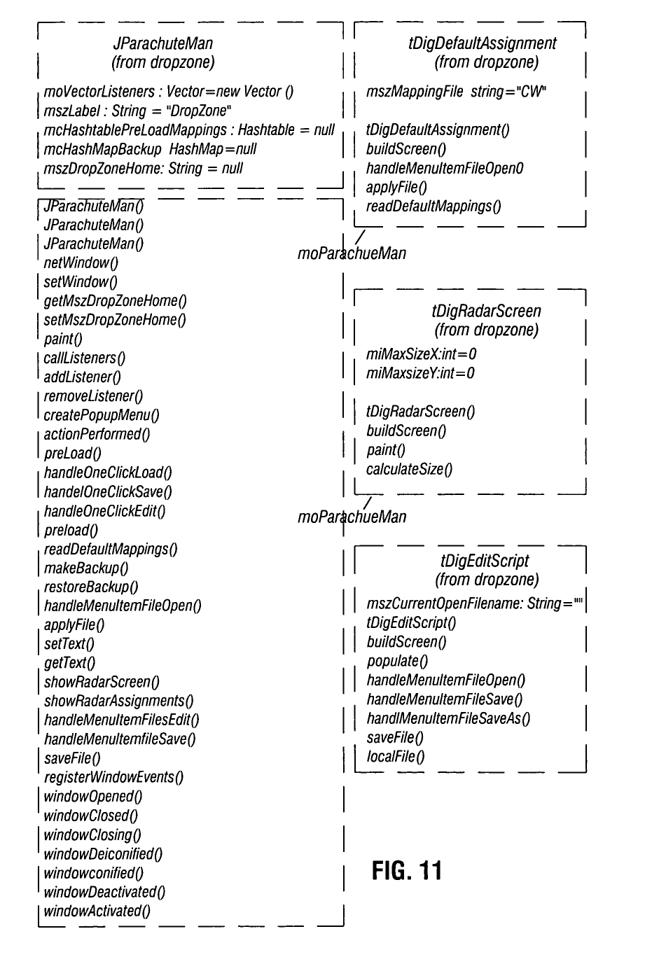

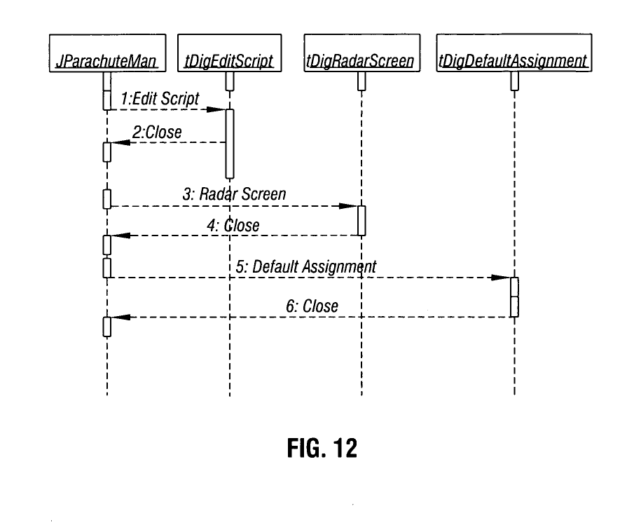

An example implementation of a DropZone™ system according to the present invention is illustrated in FIG. 11, which is a class diagram of the implementation and in FIG. 12 which is a sequence diagram of the DropZone™ component interaction.

The different embodiments of the DropZone system according to the present invention and as described above may be implemented in software, for example, stored as computer program code on a computing device or in or on a computer readable medium. In particular, the steps carried out by the DropZone system as set out in the flow diagram of FIGS. 13 to 21 may be implemented in software.

The software is executable on one or more processors in the computing device. During operation, the software is loaded from a computer readable storage medium and executed by the one or more processors. Examples of the computer readable storage medium include a magnetic storage medium, an optical storage medium, or a semiconductor storage medium, such as magnetic disks, optical disks, dynamic or static random access memories, electrically erasable and programmable read-only memories, flash memories, and so forth.

1. A method operating on a computing device for the storage of display values from one or more fields of a form of a graphical user interface (GUI) application running on the computing device, the method comprising:
in response to a save command by a user of the computing device in relation to an open form, for each field of the form containing display values, saving the display values in a data storage file, and
in response to a load command by a user in relation to an open form and a designated or default data storage file, populating the fields of the form with the display values stored in the file.

2. A method according to claim 1 comprising storing the display values in the data storage file in a user editable format.

3. A method according to claim 1 comprising storing a correlation for each field of the form in the data storage file wherein each correlation is a correlation between a field element identifier in the GUI application for that field and the display value for that field.

4. A method according to claim 1 comprising storing a correlation for each field of the form in the data storage file in a user editable format wherein each correlation is a correlation between a field element identifier in the GUI application for that field and the display value for that field.

5. A method according to claim 1 comprising storing a correlation for each field of the form in the data storage file as name/value pairs, where for each field of the form the name is an element identifier in the GUI application and the value is the display value for that field.

6. A method according to claim 1 wherein in response to a save command by a user of the computing device in relation to an open form, for each field of the form containing display values, the method additionally comprises:
creating a correlation comprising a field element identifier in the GUI application for that field and the display value for that field and storing the one or more created correlations in a data storage file, and
in response to a load command by a user in relation to an open form and a designated or default data storage file,
identifying each field where a match occurs between the field element identifiers of the fields of the form and the field element identifiers of the correlations in the file and populating each such identified field of the form with the display value stored in the file for the matched correlation.

7. A method according to claim 1 wherein the fields are box fields and the display values are data displayed in boxes on the form.

8. A method according to claim 1 wherein the fields are data type descriptor fields and the display values are data type descriptors.

9. A method according to claim 1 additionally comprising:
in response to a request from a user, displaying the form on a display of the computing device for a user to input display values in fields of the form and displaying a activator icon on the form, and
in response to a user actuating the activator icon, displaying an array of options including a save command actuator and a load command actuator.

10. A method according to claim 1 wherein saving the display values in a data storage file, comprises displaying a file save window for a user to create or select a file in which to save the data.

11. A method according to claim 1 wherein the form has a title and saving the display values in a data storage file is automatic and comprises generating a file in a default location of the computing device, naming the file after the title of the form and storing the display vlaues in the file.

12. A method according to claim 1 wherein populating the fields of the form with the display values stored in the file, comprises displaying a file picker window for a user to select a data storage file from which to load the display values.

13. A method according to claim 1 wherein the form has a title and populating the fields of the form with the display values stored in the file is automatic and comprises selecting a file in a default location with the same name as the title of the form from which to load the display values.

14. A method according to claim 1 wherein in response to a user designating a data storage file as a default file for a form, automatically populating the fields of the form with the display values stored in the file when a new version of the form is opened.

15. A method according to claim 1 wherein in response to a user making a request, displaying a screen listing GUI application element names in relation to fields of the form.

16. A method according to claim 1 wherein in response to a request by a user, displaying the contents of a data storage file on a display of the computing device in a user editable format.

17. A method according to claim 1 comprising generating an activation interface which is actuable by the user to facilitate storage of display values to a data storage file or loading of display values from a data storage file.

18. A method according to claim 1 comprising displaying an activation interface on the open form which is actuable by the user to facilitate storage of display values to a data storage file or loading of display values from a data storage file.

19. A computer program element comprising computer program code to make a computing device execute the method of claim 1.

20. A computer program element according to claim 19 embodied in or on a computer readable medium.

21. Computer executable software code stored on a computer readable medium for storing display values from one or more fields of a form of a graphical user interface (GUI) application, comprising:
software code which in response to a save command by a user of a computing device on which the software code is run, in relation to an open form, for each field of the form containing display values, saves the display values in a data storage file, and
software code which in response to a load command by a user in relation to an open form and a designated or default data storage file, populates the fields of the form with the display values stored in the file.

22. Code according to claim 21 comprising code which stores the display values in the data storage file in a user editable format.

23. Code according to claim 21 comprising code which stores a correlation for each field of the form in the data storage file wherein
each correlation is a correlation between a field element identifier in the GUI application for that field and the display value for that field.

24. Code according to claim 21 comprising code which stores a correlation for each field of the form in the data storage file in a user editable format wherein each correlation is a correlation between a field element identifier in the GUI application for that field and the display value for that field.

25. Code according to claim 21 comprising code which stores a correlation for each field of the form in the data storage file as name/value pairs, where for each field of the form the name is an element identifier in the GUI application and the value is the display value for that field.

26. Code according to claim 21 comprising code which in response to a save command by a user of a computing device on which the code is run, in relation to an open form, for each field of the form containing display values, creates a correlation comprising a field element identifier in the GUI application for that field and the display value for that field and stores the one or more created correlations in a data storage file, and code which in response to a load command by a user in relation to an open form and a designated or default data storage file, identifies each field where a match occurs between the field element identifiers of the fields of the form and the field element identifiers of the correlations in the file and populates each such identified field of the form with the display value stored in the file for the matched correlation.

27. Code according to claim 21 wherein the fields are box fields and the display values are data displayed in boxes on the form.

28. Code according to claim 21 wherein the fields are data type descriptor fields and the display values are data type descriptors.

29. Code according to claim 21 additionally comprising:
code which in response to a request from a user, displays the form on a display of a computing device on which the code is run for a user to input display values in fields of the form and displays an activator icon on the form, and
code which in response to a user actuating the activator icon, displays an array of options including a save command actuator and a load command actuator.

30. Code according to claim 21 which saves the display values in a data storage file by displaying a file save window for a user to create or select a file in which to save the data.

31. Code according to claim 21 wherein the form has a title and the code saves the display values in a data storage file automatically by generating a file in a default location of the computing device, naming the file after the title of the form and storing the display values in the file.

32. Code according to claim 21 which populates the fields of the form with the display values stored in the file by displaying a file picker window for a user to select a data storage file from which to load the display values.

33. Code according to claim 21 wherein the form has a title and the code populates the fields of the form with the display values stored in the file automatically by selecting a file in a default location with the same name as the title of the form from which to load the display values.

34. Code according to claim 21 which in response to a user designating a data storage file as a default file for a form, automatically populates the fields of the form with the display values stored in the file when a new version of the form is opened.

35. Code according to claim 21 which in response to a user making a request, displays a screen listing GUI application element names in relation to fields of the form.

36. Code according to claim 21 which in response to a request by a user, displays a data storage file on a display of a computing device on which the code is run in a user editable format.

37. Code according to claim 21 which generates an activation interface which is actuable by the user to facilitate storage of display values to a data storage file or loading of display values from a data storage file.

38. Code according to claim 21 which displays an activation interface on the open form which is actuable by the user to facilitate storage of display values to a data storage file or loading of display values from a data storage file.

39. Computer readable software code for operating on a computing device for storing display values from one or more fields of a form of a graphical user interface (GUI) application running on the computing device, comprising:
in response to a save command by a user of the computing device in relation to an open form, for each field of the form containing display values, software code which saves the display values in a data storage file, and
in response to a load command by a user in relation to an open form and a designated or default data storage file, software code which populates the fields of the form with the display values stored in the file.
